(19) United States
(12) Patent Application Publication
(10) Pub. No.: US 2010/0178233 A1
(43) Pub. Date: Jul. 15, 2010

(54) SYNTHETIC DIAMONDS PREPARED FROM ORGANIC MATERIALS

(76) Inventor: John N. Hatleberg, New York, NY (US)

Correspondence Address: WINSTON & STRAWN LLP;PATENT DEPARTMENT, 1700 K STREET, N.W., WASHINGTON, DC, 20006, US

(21) Appl. No.: 12/446,218

(22) PCT Filed: Apr. 14, 2004
(86) PCT No.: PCT/US04/11407

§ 371 Date: Apr. 17, 2009

(51) Int. Cl. C01B 31/06

(52) U.S. Cl. 423/446

(57) ABSTRACT

The present invention relates to a method of making a more permanent remembrance from a graphitizable or carbon-containing material, wherein the material is part of or embodied in an ephemeral object that signifies a power, attribute, memory, custom, tradition, emotion or symbolism associated with a life experience or event. The method includes transforming the ephemeral object to the more permanent remembrance by converting the carbon-containing material to a synthetic diamond, thus transferring the power, attribute, memory, custom, tradition, emotion or symbolism of the object or the associated life experience or event into the diamond. The synthetic diamond can be prepared by transforming the carbon-containing material to a carbon compound or carbon-containing compound; and then converting the carbon compound or carbon-containing compound into the synthetic diamond.

### BACKGROUND ART

The present invention relates to a method of making a more permanent remembrance from a graphitizable or carbon-containing material, wherein the material is part of or embodied in an ephemeral object that signifies a power, property, attribute, memory, custom, tradition, emotion or symbolism associated with a life experience or event. The method comprises transforming the ephemeral object to the more permanent remembrance by converting the carbon-containing material to a synthetic diamond, thus transferring the power, property, attribute, memory, custom, tradition, emotion or symbolism of the ephemeral object or associated life experience or event into the diamond.

The present invention seeks to transfer the powers, attributes, memories, customs, traditions, emotions and symbolism of certain plants and flowers, plant derived material, and other carbon-containing chemicals or product components into a diamond as a container. Diamond is best suited to serve as the eternal container for these properties derived from such ephemeral sources. Any gem can last forever, but only diamond can be synthesized from carbon bearing or graphitizable materials. Therefore diamonds can be created that embody properties of ephemeral materials.

Throughout history, gems have always signified power and importance. Gems are vessels. They are exquisitely designed to contain meaning. Gems are layered with and contain our feelings and emotions. Gems respond to human need; eloquently. Gems are beautiful, rare, valuable, durable, portable, magical, empowering, sexual, natural, intimate, colorful, cultural, historical, tangible, eternal, status symbols, mysterious, consoling inspiring.

One can examine any of these properties, for example beauty. In “Civilization and its Discontents,” Freud writes: “The sensation of beauty produces a particular, mildly intoxicating kind of sensation. There is no very evident use in beauty: the necessity of it for cultural purposes is not apparent, and yet civilization could not do without it. The science of aesthetics investigates the conditions in which things are regarded as beautiful; it can give no explanation of the nature of origin of beauty; as usual, its lack of results is concealed under a flood of resounding and meaningless words. Unfortunately, psychoanalysis too, has less to say about beauty than about most things. Its derivation from the realm of sexual sensation is all that seems certain; love of beauty is a perfect example of a feeling with an inhibited aim. Beauty and attraction are first of all the attributes of a sexual object.”

The first gem was picked up and admired for beauty. One of the earliest known pieces of jewelry was found in a grave near Monaco. It is a necklace of three fish vertebrae and dates to 25,000-18,000 BC. The impulse to create this necklace was likely due to an urge to adorn—to become more sexually attractive or to increase one's stature in the eyes of the community. Primal desire for beauty through gems calls to women, it may be imprinted into the female genes.

The second probable urge to string these early fish bones into a jewel was due to a magical or talismanic property. This shifts the importance of what a jewel is to what it does. In her book on “Magical Jewels,” Joan Evans writes; “Rarity, strangeness and beauty have in them an inexplicable element, and the inexplicable is always potentially magical. The belief in the magical properties of stones and gems is, indeed, of immemorial antiquity; a cuneiform inscription gives a list of stones facilitating conception and birth and inducing love and hatred, and another mentions a ring set with a stone worn as an amulet. Even in the ages when written records fail us, we have no reason to suppose the absence of such a belief”.

Throughout much of history gems were recognized as having important powers. Thomas Nicols wrote in his work “Faithfull Lapidary” of 1659 “of gems and pretious stones, the effects of which by Lapidists are said to be: the making of men rich and eloquent, to preserve men from thunder and lightning, from plagues and diseases, to move dreams, to procure sleep, to foretell, things to come, to make men wise, to strengthen memory, to procure honours, to hinder fascinations and witchchrafte, to hinder slothfulness, to put courage into men, to keep men chaste, to increase friendship, to hinder difference and dissention, and to make men invisible and many other strange things are affirmed to them and ascribed to them.” (“The Curious Lore of Precious Stones”, George Frederick Kunz, Dover, 1913, p. 7.)

There is a plausible basis for the belief in the properties or attributes of gems. Lodestone serves as an excellent example. Near the end of his life Ivan the Terrible was occupied with his precious stones and treasures. In an account by Sir Jerome Horsey the ruler called for a specimen of the material that was hung “with a chain of needles”. Ivan the Terrible then exclaimed “The loadstone you all know has great and hidden virtue, without which the seas that compass the world are not navigable, nor the bounds nor circle of this earth cannot be known.” (Kunz, p. 172.)

Kunz, p.v. Keeping this sense of cause and effect, we in the twenty first century might do well to marvel more at such gems as quartz, for without this gem and the silicon that derives from it, the magic of computers would not exist.

Pliny was a skeptic of the magic ascribed to gems. His “caution” exemplifies the Greek approach to examining the natural world. It was not until the rise of the schools of the Healers in the second century AD that an Eastern alchemical approach to gems became and remained predominant. It therefore follows that “the influence exerted by precious stones was assumed in medieval times without question, but when the spirit of investigation was aroused in the Renaissance period, an effort was made to find a reason of some sort for the traditional beliefs. Strange as it may seem to us, there was little disposition to doubt that the influence existed; this was taken for granted, and all the mental effort expended was devoted to finding some plausible explanation as to how precious stones became endowed with their strange and mystic virtues, and how these virtues acted in modifying the character, health, or fortune of the wearer”. (Kunz, pp. 1,2.)

These gems were so revered that they must have powers. One spent one's efforts ascertaining what those powers might be. Even a man such as Leonardo would assume that the royal-colored amethyst held powers—and decided that the power would be to make men wise in business matters.

The early rarity and resultant mystique of diamonds led to their being allotted more properties and attributes than perhaps any other gem. Subsequent histories have reinforced this valuation. The virtues of a diamond were to “resist poison,” “to poison” and many affects in between including “to put away feare, to give victorie in contention, to help them that be lunatike and phrantike.” (“Magical Jewels of the Middle Ages and the Renaissance, particularly in England”, Joan Evans, Clarendon Press, 1922, p. 144.) Elixirs of precious stones, the most precious and therefore supposedly efficacious being constituted of diamond, were administered to Charles VI of France and Lorenzo de Medici on their deathbeds. (“Panmineralogicon”, Robert Love, Oxford, 1661, p. 77.)

According to Hindu doctrine one manner to harness the energy of a diamond included reducing them to ashes over a period of days to create a potion that would “Conduce to longevity, general development of the body, strength, energy, beauty of complexion, and happiness, giving an adamantine strength to the limbs”. (Kunz, p. 378.)

India was the only large source of diamonds for most of the last two thousand years. Up until the 17th century any diamond weighing over ten carats was kept in India. In Europe during the Middle Ages all that was known about diamonds was that they came from India, that they were very rare and that they were unbelievably hard. It was not until 1379, during the reign of Charles V, that there is any record of any diamond in Europe at all.

It was the incredible hardness of a diamond and what that represented to the people of the time that gave rise to the legends ascribed to it. The word diamond arises from the Greek work “adamas,” meaning unconquerable. Only a ruler could own or wear diamonds and their magic powers were believed to make one invincible. To the amazement of mankind, diamonds were resistant to fire and harder than steel. Approximately a century later, in the house of Burgundy, the strength and durability of a diamond that had represented a ruler's invincibility shifted as they became available to the lesser nobility. Those properties then became the perfect vehicle to convey the supreme strength, fidelity and devotion that characterize a marriage.

Diamonds are vessels, containers, repositories of our most heartfelt feelings and emotions. Diamonds are potent. A diamond is the perfect object to contain meaning. Although this is often obscured by their value, to contain meaning is their primary function. They fulfill this function more successfully than any other object. Diamonds concurrently internalize and shed light. In giving off light they become larger than themselves, allowing them to be at once abstract and symbolic, yet the concrete. Historically this function to contain meaning would have been ascribed to the talismanic property within the gem. The modern corollary recognizes the staying power of this function yet credits our own ability to deposit meaning into these worthy vessels as the rationale behind their power.

George Frederick Kunz writes in “The Curious Lore of Precious Stones” that “Precious stones have been used at different times and among different peoples (with) curious ideas and fancies that have gathered around them. Many of these ideas may seem strange enough to us now, and yet when we analyze them we find that they have their roots either in some intrinsic quality of the stones or else in an instinctive appreciation of their symbolical significance. Through manifold transformations this symbolism has persisted to the present day . . . It is not the object itself, but the idea for which it stands and which it incorporates, that gives confidence to the wearer . . . This tendency to give a substantial visible form to an abstract idea is so deeply rooted in humanity that it must be looked upon as responding to a human necessity.” (Kunz, pp. V,25,26.)

What is and what is not a talisman or amulet is a purely personal matter. For some people anything can become an amulet; others feel no need at all for magic. (“The Great Book of Jewels” Ernst A. and Jean Heiniger, Edita Lausanne, 1974, p. 54.)

For Sigmund Freud, gems serve as prime examples of “transitional objects.” A transitional object tends to be portable, durable, intimate and natural. When such an object is given to another, some of the power of the owner, a place or an experience is passed on with the gift. This remembrance may be given for love, luck, consolation or many other purposes. When Pope Innocent II wrote to Richard the Lionhearted in 1198 concerning a gift of four rings he wrote “Heed the secret significance of my gift rather than the gift itself. The circular shape of the gold rings set with precious stones refers to eternity, their number to Constantia mentis, constancy of spirit, the gold to spientia, wisdom.” (Heiniger, p. 54.)

“These mystic interpretations of gems, pearls, and certain forms of jewelry lead us to the very heart of superstition. They represent one of the last links with the shamanism and animism that lived on in primitive cultures well into the present century. Which of us hasn't a special relationship with a piece of jewelry we inherited? Even today we feel a special fondness for a jewel that belonged to a person now dead and are unhappy if we lose it . . . The two primary functions of jewels, to enhance the wearer's beauty and display his wealth, are turned inward, so to speak, by their quality as amulets.” (Heiniger, p. 11.)

Having developed a case for diamonds as vessels for meaning, both historically and currently, a similar case will be presented for flowers, plants, plant derived and carbon containing materials.

There is an affinity between gems and flowers and foliage (plants, plant derived or carbon containing materials). This is true even from their very origins. A Persian legend of the origin of diamonds and precious stones show that, “in the East these beautiful objects were looked upon as the source of much sin and sorrow. We are told that when God created the world he made no useless things, such as gold, silver, precious stones and diamonds; but Satan, who is always eager to bring evil among men, kept a close watch to spy out the appetites and passions of the human mind. To his great satisfaction he noted that Eve passionately loved the many colored flowers that decked the Garden of Eden: he therefore undertook to imitate their brightness and color out of earth, and in this way were produced colored precious stones and diamonds.” (Kunz, p. 25.)

There is a further affinity between gems and flowers as regards their function. The use of the lotus in Egypt is traced as far back as the Vth Dynasty. (2494-2345 BC.) It represented Upper Egypt, just as papyrus was symbolic of the Lower Kingdom. The lotus was seen as the womb from which mankind emerged. Its use was both religious and secular. The lotus was widely used: “As soon as the ceremony of anointing the precious unguents was completed, servants brought a lotus to be held in the hand during the feast. The guests were then presented with necklaces that included flowers, mainly the lotus. A garland might also be placed around the head and a single lotus attached to droop over the forehead; for a lotus bud was an accepted part of a woman's headgear.” (“The Culture of Flowers”, Jack Goody, Cambridge University Press, 1993, p. 39.) The lotus was also used extensively as a crown.

This similarity of function of gems, jewelry and flowers is shown throughout history and cultures. In Chinese the word “hua” stands for female beauty and “ru hua si yu” means “as beautiful as flowers and jade”. (Goody, p. 371.) In fifth century India, “Royal persons of both sexes, were expected to wear crowns, necklaces, bracelets, armbands, earrings and garlands . . . Throughout early literature women are as closely associated with flowers as with jewelry, with one form substituting for the other”. The prologue to Kalidasa's play Sakuntala, runs:
Sensuous Women
in summer love
weave
flower earrings
from fragile petals
of mimosa
while wild bees
kiss them gently (Goody, p. 325.)

There is furthermore an affinity between gems and flowers and foliage as regards their properties, symbolism and ability to serve as containers of meaning. Today, diamonds and roses are the two most successful objects used to symbolize love. This intertwining of their powers dates to the very earliest of engagement rings. Diamonds only arrived in Europe in modest numbers circa 1450. One generation afterwards marked the betrothal of Constanza Sforza and Camilla d'Aragona. Theirs is one of the first records of a diamond being given to seal an engagement. A series of miniatures now in the Vatican heralds the occasion. The miniatures depicts the divinity Hymen, shown as a handsome youth wearing a garland of roses and a tunic festooned with the images of the diamond ring that would consecrate the marriage.

There is furthermore an affinity between gems and flowers and foliage as regards rituals, customs and expressions of feeling. Concerning ring wearing practices in England, “a man is supposed to carry a ring on his first finger if he wisher to get married, the second if he is engaged, the third if he is married, the fourth if he wants to remain single”. Consider the parallel in the realm of roses whereby “a rosebud with its thorn and leaves means ‘I fear, but I am in hope’; If one turns the bud upside down, that means: ‘One mustn't fear or hope’ . . . stripped of its thorns, the rose means ‘there is everything to hope for’, while stripped of its leaves it means ‘there is everything to fear’”. (Goody, p. 238.) Other meanings of using gems and flowers as symbols may be affected by their number, their placement and certainly their color.

The shared properties of gems and flowers are not limited to portraying love. Again this parallels the concurrent functions of gems that have been previously described. Many of the examples are medicinal. In China, “the peony (stands) for wealth and sensuality. The begonia was the feminine flower par excellence because it prefers cool and shady places, so that it enters into many stories of forlorn love. The iris was linked to ideas about fertility and the birth of sons. An iris broth was used in a ceremonial bath in parts of South China and one could drink an infusion in wine, which was believed to prolong life and to promote intelligence; together with Artemisia, it was hung on doors for protection. The red pomegranate blossom was believed to ward off bad fortune as well as signifying happiness and fertility. The day lily was the herb of forgetfulness, helpful in alleviating the pains of childbirth but also worn in pregnancy to ensure the birth of a son”. (Goody, p. 370.) As late as the 1950's, “the use of flowers for contraceptive purposes was even advocated by official sources, in particular the honeysuckle, safflower blossoms, the buds of aubergine flowers, as well as other vegetable products.” (Goody, p. 378.) One can match gems and flowers based on their shared attributes.

The opportunity for plants to signify a power, attribute, memory, custom, tradition, emotion or symbolism associated with a life experience, event or to serve as a transitional object are seemingly limitless. Consider the potential of this concept in the introduction to “Hesperides” by R. Herrick:
I sing of Brooks, of Blossomes, Birds, and Bowers:
Of April, May, of June, and July-Flowers.
I sing of May-poles, Hock-carts, Wassails, Wakes,
Of Bride-grooms, Brides, and of their Bridall-cakes
I sing of Dewes, of Raines, and piece by piece
Of Balme, of Oyle, of Spice, and Amber-Greece.
I sing of Times trans-shifting; and I write
How Roses first came Red, and Lillies White.
I write of Groves, of Twilights, and I sing
The Court of Mab, and of the Fairie-King.
I write of Hell: I sing (and ever shall)
Of Heaven, and hope to have it after all.

In disseminating aspects of this poem one could discern that “May-poles, Wassails, and Wakes” are powerful symbols of traditions and holidays that one could associate with specific flowers. The same is true for “Bride grooms, Brides and . . . Bridall-cakes” in terms of how they represent life passages or stages of life. Throughout the poem the references are lush with allure and romance, primary attributes of both gems and flowers.

It has been identified that flowers and foliage signify affinities of origin, function, properties, symbolism, ritual, customs, expressions of feeling, holiday and romance. The easy recognition of the affinities between gems and flowers increases the publics appreciation for the diamonds that result from them. Most importantly, consider that the success of gems and flowers (or plants . . . ) as containers of meaning has been substantiated. Consider further that flowers (or plants . . . ) suffer as containers of meaning in that they are ephemeral whereas gems are eternal.

In his “DeGemmis et Coloribus” of 1585 Jerome Cardan describes how gems have powers, which unlike those of plants, remain undiminished by time: “Quare haud tutum est lapides gerereincognitos, et adsidue secum ferre; . . . gignunt enim in animis nostris varios effectus, conrtumaciae, timoris, auariciae, odii, inuidiae, petulantiae, tristitiae, iraae, quorum medio hominess evertuntur . . . Facile intelliges, vitae, nostre cursum forunamque ferme totam ex moribus nostris et affectibus pewndere: quare etiam magnum afferre posse detrimentum aut auxililium, gestamen lapidum atque gemmarum”. (Evans, p. 145.)

Similarly Kunz writes: The love of precious stones is deeply implanted in the human heart and the cause of this must be sought not only in their coloring and brilliancy but also in their durability. All the fair colors of flowers and foliage, and even the blue of the sky and the glory of the sunset clouds, only last for a short time, and are subject to continual change, but the sheen and coloration of precious stones are the same today as they were thousands of years ago and will be for thousands of years to come. In a world of change, this permanence has a charm of its own that was early appreciated. (Kunz, pv.)

The history of the development of synthetic diamonds proceeds in increasing refinement. The original discovery dates to the laboratories of Bell Laboratories in 1954. The amazing, technical background is well documented in the art and is reviewed elsewhere. The process began with the creation of industrial diamond material derived from methane or graphite, proceeds to small gem materials with poor color and extensive inclusions, to the present condition whereby large fine clean colored synthetic gem diamonds are now entering the market.

In the last few years, the most significant diamond synthesis related news concerned the announcement by the diamond manufacturer Lazare Kaplan that a high pressure high temperature (HPHT) treatment of diamonds that GE had researched for years allowed for the dramatic color improvement in off color, generally brown, diamonds.

The first limited number of synthetic gem diamonds were offered for sale to the

American public at an industry trade show in the summer of 1999. In 2002, an American firm succeeded in creating synthetic diamonds from the cremated remains of people and pets. In 2003, two other American companies announced plans to increase production capacities to market vast numbers of gem quality synthetic grade diamonds.

At this point, the method of fabrication of gem quality synthetic diamonds is well known in the art. The genius of the initial patents confirmed the possibility of the process. Many of the initial patents are held by a team of GE scientists often headed by Robert H. Wentorf Jr. Being an active field the potential has continued to progress from these origins.

Refinements to the process often focus on increasing the size of the reaction chamber—to accommodate the growth of larger crystals; the development of a more pure feedstock—to minimize metal inclusions, lead to regular crystal growth and increase the life of the synthesis equipment; or methods to vary the temperature gradient in the growth cell—to encourage the precipitation of diamond onto the seed crystal without dissolution of the diamond seed.

Despite this increasing manufacturing knowledge and cost reductions due to enhanced manufacturing techniques, synthetic diamonds are still not accepted as a substitute for natural diamonds or as a companion product. They are perceived as being less desirable than natural diamonds. Thus, there remains a need for a method of increasing consumer acceptance of such materials.

A company called LifeGems is promoting the creation of synthetic diamonds from the cremated remains of a loved one (see US patent application 20030017932). While the wearing of a ring that contains this type of synthetic diamond may give comfort to some individuals, these products have not yet gained significant commercial acceptance, possibly due to the sacred nature of the material used to make the diamond.

The present invention now resolves the problems and disadvantages of the prior art and provides synthetic diamonds that are desirably produced from much more meaningful carbon sources. In addition, there are significant new markets for synthetic diamonds based on the teachings and discoveries of the present invention.

### SUMMARY OF THE INVENTION

The present invention relates to a method of making a more permanent remembrance from a carbon-containing material that is part of or embodied in an ephemeral object that signifies a power, attribute, memory, custom, tradition, emotion or symbolism associated with a life experience, a treasured object or a symbolic or important event. The method comprises transforming the ephemeral object to the more permanent remembrance by converting the carbon-containing material to a synthetic diamond, thus transferring the power, attribute, memory, custom, tradition, emotion or symbolism of the ephemeral object or the associated life experience or event into the diamond.

The synthetic diamond is advantageously prepared by transforming the graphitizable or carbon-containing material to a carbon compound or carbon-containing compound; and converting the carbon compound or carbon-containing compound into the synthetic diamond. The preferred carbon compound or carbon-containing material is graphite or methane. The graphitizable material comprises or is derived from any one of a wide variety of carbon-containing materials, including organic plant materials or chemicals or components of a beverage, food, perfume, or other liquid-containing product. In particular, the carbon-containing material can be paper, plastic, a polymer, cloth made from a natural or synthetic fiber or yarn, wood, or combinations of these. Furthermore, the carbon-containing material can be a chemical or component of a beverage, food, perfume, or other liquid-containing product, or paper, plastic, a polymer, cloth made from a natural or synthetic fiber or yarn, wood, or combinations of these.

The carbon-containing material can represent or be part of a proposed gift that is associated with the life experience or event and only the diamond is bestowed upon a recipient by a gift-giver. The gift may be first given to the recipient by the gift-giver and the graphitizable material of the gift is later converted into the synthetic diamond. Of course, the gift-giver and the recipient can be the same person.

The method can further comprise bestowing the synthetic diamond on a recipient as a representation of the power, attribute, memory, custom, tradition, emotion or symbolism associated with the life experience or event, wherein the synthetic diamond acts as a container that holds the power, attribute, memory, custom, tradition, emotion or symbolism associated with the life experience or event. The life experience or event can be an achievement, celebration, vacation, honeymoon, holiday, or season. Also, the life experience or event represented by the object can be further embodied in a tangible item associated with the object, life experience or event wherein the tangible item includes the carbon-containing material that is transformed to the synthetic diamond.

### DETAILED DESCRIPTION OF THE PREFERRED EMBODIMENTS

In the following detailed description, the term “remembrance” is used to mean something that serves to keep in or bring to mind in a positive manner, a power, attribute, memory, custom, tradition, emotion or symbolism associated with a life experience or event.

Also, the terms “carbon-containing material” or “graphitizable material” mean a material that is or that can be converted into carbon or graphite, and in particular into the type or form of graphite that can be converted into synthetic diamond by conventional synthetic diamond generation techniques or methods.

The term “ephemeral object” means an object that is provided for use, consumption, wearing, display, conveying (e.g., messages), and can be used, consumed, worn, viewed, read, heard, tasted, and the like. As noted, the object is associated with a life experience or event and is an ephemeral remembrance of the experience or event. In some cases, the object is of a more permanent nature, but becomes obsolete or less favored compared to newer technology or developments over time.

The present invention now provides synthetic diamonds that are desirably produced from meaningful but ephemeral objects that are at least partly made of carbon sources. Consider the benefits of utilizing flowers, plants or objects made of other organic materials that are capable of being transformed to pure carbon, graphitized and finally synthesized to diamond and by doing so, these organic materials become eternal containers of meaning.

Magicians, seers, doctors and scientists gazed into their respective philosopher's stones throughout the centuries in search of the manner to turn lead into gold. How much more beautiful to now be able to create diamonds from flowers, plants or other organic materials. These are called “Diamond Vessels” as a group. Diamond is elemental; it is pure carbon and carbon is the basis of all life. Flowers, being of life, can in turn be reduced to carbon. By taking that carbon and coupling it with intense heat and high pressure, the process used for the synthesis of diamond, flowers can be transmuted to diamond.

Absent from this litany of diamond synthesis discovery is a method to imbue the created diamond with the integral elements of symbolism and meaning. Their inclusion is central to diamond's allure and appeal. This crucial aspect has been entirely lacking in the manufacture and perception of synthetic diamonds. Synthetic diamonds conjure up images of laboratories and test tubes. With great beauty and a sense of marvel the present invention of synthesizing diamonds with the carbon of flowers ushers a striking fulfillment to the history of diamond synthesis. In this manner, synthetic diamonds will be true not only to its composition, method of birth' and form—its natural history; but as importantly to its allure and mystique—its cultural history.

Diamond's primary meaning in conveying power, properties, attributes, memories, customs, traditions, emotions or symbolism associated with a life experience, event or object will now be inextricably woven into the complete fabric of their creation. The ephemeral beauty of flowers (plants, plant derived and carbon containing material) is coupled with the eternal beauty of the diamond. The flower must wither, but may now bloom again as a diamond. Given that the raw material of manufacture often comes from the natural and pure flower, an additional benefit to this process of synthesis, is that the public will often perceive it as ‘natural’, versus the present perception of diamond synthesis as industrial or engineered. The gift of a flower, given in the promise of being a container of meaning, is transformed to the eternal promise of that flower in the symbolism of a diamond. Organic becomes inorganic; blossom and petal become crystal.

Therefore consider the benefits of utilizing flowers, plants or other organic materials that are capable of being transformed to carbon, graphitized and finally synthesized to diamond. These materials therefore become desired eternal containers of meaning. In sum, eternalize what you cherish.

Although the discussion herein has focused on flowers, by extrapolation this holds true not just for flowers but plants, plant derived and carbon containing material. Numerous examples of the cultural importance of flowers have been stressed. This background does not exist in the continent of Africa. Flowers are not much in evidence on that continent. However the roles associated with flowers are transferred to other parts of plants; their bark, their seeds, their stems and wood. (Goody p. 378.) In one embodiment, flowers and other plants are made into synthetic diamonds. These plants represent or are symbols of luxury, emotions, holidays, luck, fertility, longevity, life passages (birth, graduation, marriage, divorce, retirement, birthdays, death) and other events. Their ephemeral symbolism can be converted to a more permanent and long lasting remembrance by first converting the plant material to carbon or graphite and them forming a synthetic diamond from the carbon or graphite.

A parallel history of the use of flowers and plants and their association to powers, symbolism and attributes can be described but their success as a transitional object is limiting given their ephemeral characteristics. A rose is well known as a symbol of love and is generally acknowledged as a gift that symbolizes one's love for another. After the rose, the chrysanthemum holds more widespread attributes than any other flower. In China, the chrysanthemum is one of “the four gentleman of flowers,” i.e., one of the flowers chosen to represent a season. For a millennia, chrysanthemums in China have represented fertility, longevity, ease in retirement and joviality. Part of this is due to their growth in autumn and into winter. In contrast, for centuries in France, Italy and Catholic areas in southern Germany chrysanthemums have represented death. Certain types of plants and flowers have been worn or used in certain times in certain ways in certain places to convey different meanings. Someone would welcome a gift of a chrysanthemum as the perfect gift to wish for one's longevity. The same gift, particularly in France would be feared if given to someone who is still living.

The symbolism, powers and attributes of the cherry and orange blossoms are found in Kyoto traditions for celebrating the fleeting quality of youth and beauty. Fertility is also symbolized by Maypoles or daisy chains for children. Flowers also have been used as medicines, with lavender to help menstrual cramps being an example.

The flowers can be converted into graphite or methane and then made into synthetic diamonds as noted herein. The diamonds then become a permanent remembrance of the experience or event that is symbolized by the flowers.

Various other life experiences or events, such as achievements, celebrations, vacations, honeymoons, holidays, or seasons, can be converted into remembrances through the transforming of flowers or other tangible items associated with the experience or event into synthetic diamonds. In this way, a flower from a particular location that is visited, or an article connected with an important event can be converted to a carbon containing compound and then to a synthetic diamond.

A number of non-limiting examples can be provided. For acknowledgement of a particular accomplishment or achievement, flowers are generally given. In addition, champagne is often provided to toast the accomplishment. The attribute of luxury is found in the use of a Moet Hennnessey or Dom Perignon champagne, for example, and the grapes that are used to make the champagne, or even the champagne itself, can be the starting carbon-containing material for graphitization and conversion into the carbon compound or carbon-containing compound that is eventually used to create the synthetic diamond. For liquid products, the liquid can be removed or evaporated and the remaining residue is burned or otherwise incinerated to create the carbon-containing compound.

Similarly, a celebration of a particular event can have many variations. Champagne and other beverages can be consumed, and presents are often given. Certain presents of an ephemeral nature can be converted to the carbon-containing compound. Other carbon-containing items, such as letters, cards or other printed paper products expressing congratulations, clothing such as a cap and gown for graduation, a blanket that was wrapped around a newborn, or a particular uniform or outfit that was worn on the occasion, can all be converted to carbon compounds or carbon-containing compounds. Various carbon-containing beverage ingredients or components can be made into diamond cocktails to represent different drinks that now can be worn, or they can be used to represent the occasions represented by the different diamonds. A perfume or cologne worn on the occasion, or the carbon-containing chemical components or constituents thereof; can also be converted. Also, celebratory cigars are often passed out to attendees of a particular event or to celebrate a particular occasion: diamonds can be made from these cigars or other tobacco products.

Setbacks can also be remembered, if desired. For example, poison ivy can be made into a diamond that is symbolic of a failed marriage or divorce.

Specific embodiments follow:

### Gifts of Eroticism:

Perfume—attribute of luxury, Chanel No. 5 or any floral designer perfume

Flowers: Roses, orchids, etc.

Expensive chocolates

### Power Symbolism:

Oak—characteristic of masculinity—for men

Cuban cigar—attribute of luxury, men or manliness (i.e., “tobacco diamonds”)

### Life Passages or Events:

Honeymoon—a life experience, made from flowers from where you honeymooned

Wedding: flowers, champagnes, certain treasured gifts that were received

Divorce: poison ivy, black roses

### Traditions:

Christmas—remembrance, changes each year

Lilies—symbolic of Easter

Holidays or Seasons—family events: gift giving, Christmas Trees, Cherry pies, Turkeys, Pumpkins, etc.

Symbols:

Chrysanthemum—longevity, financial security in retirement

Tulips—attributes of good luck, fortune, find a man, fertility, make you smarter

Tiffany Rose—exclusive for Tiffany from Tiffany roses

### Transitional Objects or Items

Plant derived—love letters, photographs, books, or drawings; clothing, such as blue jeans or leather jackets; food items, such as popcorn leftover from “Return of the King” opening; furniture (e.g., a baby's high chair or crib); or a home (2×4s left over from house being torn down). These are merely examples but many others can be devised by skilled artisans.

Generally, the ephemeral object can be a memento, souvenir, letter, photograph, article or other object that is being maintained as a remembrance of an occasion, person, life experience or event. The importance of the object can be due to its symbolism of the event or experience of because of the admiration or affection toward the person who provided the object. As the object itself can deteriorate over time, the present invention proposes to convert the objects themselves into graphite by suitable known pyrolysis or incineration processes or the like and then to use the graphite to make the synthetic diamonds.

Often, the ephemeral object is already consumed, but its identity signifies the power, attribute, memory, custom, tradition, emotion or symbolism associated with the life experience or event. As noted, champagnes, perfumes, flowers or other objects associated with the experience or event have been consumed, but are re-created and are available on a continual or seasonal basis. A current version of the object can thus be converted into the graphite that is used to form all or part of the synthetic diamond. By taking these materials and converting them into carbon or graphite followed by the coupling of the carbon or graphite with intense pressure and high heat, these materials can be transmuted to diamond and made to endure a much greater time or even be everlasting.

It is recognized that in some situations the amount of carbon-containing material available from the object may be insufficient to provide the amount necessary to form the synthetic diamond. For example, a perfume generally contains very small amounts of the essence or compound that provides the desirable odor. To generate sufficient carbon or graphite from such compounds could be cost prohibitive, since extremely large quantities of the compound compared to the amount that is actually present in the perfume would be required to prepare the diamond. According to the invention, it is of course well recognized by the skilled artisan that the symbolism and permanence of ephemeral object can be achieved by using at least part of the graphite used to form the diamond derived from such materials, with the balance of the graphite being of the conventional form that is for making synthetic diamonds. The invention covers the use of any amount of graphite derived from the object in the making of the diamond. Continuing with the perfume example, if the odiferous compound is present in the perfume at an amount of 1%, a synthetic diamond that is made from graphite that contains 1% of graphite from the carbon-containing material of the perfume is certainly representative. This can facilitate manufacture of the diamond as well as reduce the costs of manufacturing it.

It is also possible to utilize a tangible item that is representative of the ephemeral object as the carbon-containing material to be graphitized. Again, for the perfume example, it is entirely allowable to use the flowers or organic compounds that provide the odor of the perfume as the carbon-containing material that is to be graphitized and formed into the synthetic diamond. And again, only part of the overall amount of graphite needed to form the diamond can come from the tangible item.

In other circumstances, a plurality of objects or tangible items can be provided as the carbon containing material that is graphitized and used to prepare the diamond. For example, to remember an important person or loved one, that person's clothing, love letters, ephemeral gifts, items that the person liked or desired, or other remembrances of the person can be processed together to provide the necessary amount of graphite to form the diamond. Accordingly, the term “diamond cocktails,” as used herein, refers to synthetic diamonds formed from graphite mixtures derived from different objects, items or carbon-containing materials, whether representing a person, event (e.g., programs, records, or clothing from a concert), or the components of a drink or beverage.

The history of the development of synthetic diamonds proceeds in increasing refinement. The original discovery dates to the laboratories of General Electric in 1954. The amazing, technical background is well documented in the art and is reviewed elsewhere. The process begins with the creation of industrial diamond material derived from methane or graphite, proceeds to small gem materials with poor color and extensive inclusions, to the present condition whereby large fine clean colored synthetic gem diamonds are now entering the market.

Absent from this litany of diamond synthesis discovery is a method to imbue the created diamond with the integral elements of love and romance. Their symbolic inclusion is central to diamond's allure and appeal. This crucial symbolism has been entirely lacking in the manufacture and perception of synthetic diamonds. Synthetic diamonds conjure up images of laboratories and test tubes. With great beauty and a sense of marvel the present invention of synthesizing diamonds with the carbon of rose ushers a striking fulfillment to the history of diamond synthesis. In this manner, synthetic diamonds will be true not only to its composition, method of “birth” and form—its natural history; but as importantly to its allure and mystique—its cultural history.

Diamonds are symbols of beauty. The ephemeral nature of the experience or event, or even of the articles that symbolizes such experiences or events, are coupled with the eternal beauty of the diamond. The flowers or other articles will wither and die, but their beauty can be made permanent in the synthetic diamond. Given that the raw material of manufacture comes from the natural materials, an additional benefit to this process of synthesis is that the public will perceive it as “natural” versus the present perception of synthetic diamonds as industrial or engineered.

In order to produce synthetic diamonds according to the present invention, it is first necessary to select a suitable material that can be converted into a diamond by the processes disclosed herein. Preferably, an organic material that is capable of being converted to graphite is used. Suitable materials include any kind of organic plant material, such as flowers, including roses, tulips, daffodils, carnations, chrysanthemums, lilies, and any others that can be given alone or in a bouquet. While one type of flower can be used, it is also within the scope of this invention to combine flowers into bouquets of different flowers and use that material to create the graphite that is necessary to prepare diamonds according to the invention.

Other types of organic plant material can be used, if desired. Such materials include all types of plants, in the form of plants, bushes, or trees, as well as the fruits themselves, or any of a wide variety of vegetables or other edible plants. Of course, foods, particularly exotic foods, have ephemeral beauty, and these can be converted to a more permanent form by conversion to diamonds. The same is true of beverages or perfumes. A chemical that represents the flavor of the beverage or the odor character of the perfume can be converted into graphite or methane and then be used to form synthetic diamonds. These are illustrative of the many types of materials that can be converted according to the present invention. In contrast, it is understood that mammal (i.e., human or animal) remains are not suitable or appropriate types of materials that would be converted to diamonds according to the present invention.

As noted above, it is not necessary for the gift-giver to actually purchase and bestow the gift on the recipient. Instead, it is more likely for the gift-giver to only give the diamond as symbol of the life experience or event. It is the symbolism of the gift that is conveyed when only the synthetic diamond is bestowed upon the recipient. Of course, it is also within the scope of this invention for the gift-giver to first present the recipient with the material of for the person to utilize an article that symbolizes the experience or event, gift, and then at later date, to have the material or article converted to a synthetic diamond.

The material is first converted into the necessary starting material to make the synthetic diamonds. While a form of carbon is required, solid forms such as graphite or gaseous forms such as methane can be used. The most preferred material is a carbon source that is obtained in an amorphous form that has been subjected to extensive graphitization.

Thereafter, the graphitized amorphous carbon is forwarded to the appropriate synthetic diamond forming equipment. A number of techniques utilizing different types of equipment are known, as evidenced by various patents that disclose techniques for preparing synthetic diamonds from a source of carbon. These include U.S. Pat. Nos. 6,270,548, 5,908,503 and 5,503,104. To the extent necessary, the entire contents of these patents are incorporated herein by reference thereto.

A brief synopsis of the preferred technique for synthetic diamond synthesis as it applies to the present invention is described as follows.

The method of the present invention includes the steps of loading a growth cell with polycrystalline CVD diamonds, suitable catalyst, and the source of graphitized amorphous carbon. Then, pressure and heat are applied to the loaded cell in such a way as to induce a temperature gradient across the growth cell. Pressures and temperatures throughout the growth cell are such that diamond is the thermodynamically stable form of carbon.

The article of the present invention is produced in a growth cell whose size and shape is defined by the apparatus that supplies the high pressure to the materials contained in the growth cell. The high pressure apparatus is any piece of equipment capable of inducing the necessary pressures to sustain diamond formation within the enclosed growth cell. It can include equipment used in the prior art method of high pressure diamond gem manufacture. Such an apparatus is capable of withstanding high pressures and high temperatures. This equipment is well known in the art. A typical apparatus is described in U.S. Pat. No. 3,297,407, which is also incorporated herein by reference. Briefly, this apparatus includes an annular belt member having a convergent divergent aperture therethrough. A pair of frustoconical oppositely positioned and movable punches move into the opening to define a reaction chamber. A growth cell, containing specimen material, is placed in the reaction chamber and compression thereof through motion of the frustoconical punches subjects the sample material to high pressures. Many variation of such apparatuses have been disclosed. They include multi-piece dies with gaskets between individual segments, such as is described in U.S. Pat. Nos. 2,941,244 and 2,947,034, which are also incorporated herein by reference. Other types of apparatuses include a given closed reaction chamber that is defined by a plurality of interfitting overlapping pressure resisting members all of which are in a sliding relationship. The arrangement provides a reduction in volume of the growth cell along more than two axes. Such an apparatus is detailed in U.S. Pat. No. 3,271,502 which also is incorporated herein by reference.

Pressures within the growth cell typically range from about 5-7 Gpa. The temperature is typically maintained at about 1300-1800 degrees Celsius. Heat can be supplied by any method known in the art, for example, electrical resistance heating can be employed to attain necessary temperatures. It is important that the heat be applied in such a manner as to produce a temperature gradient within the growth cell so that the growth cell is hottest at the carbon source and coolest at the polycrystalline CVD diamond. In this way, the metallic solvent is saturated with carbon when in contact with the carbon source and is supersaturated with carbon when in contact with the polycrystalline CVD diamond. There is, therefore, a driving force to dissolve, transport and redeposit diamond from the carbon source and onto the polycrystalline CVD diamond. Polycrystalline CVD diamond is well known in the art. CVD diamond can be produced by various methods including, but not limited to, DC plasma, microwave plasma, and hot filament CVD techniques. For use in the present invention the method of producing the polycrystalline CVD diamond is not critical. Typically, a plate or disc of polycrystalline CVD diamond will be place in the growth cell.

Suitable catalysts for high pressure diamond growth are well known in the art. They include metals such as iron, aluminum, nickel, cobalt, tantalum, manganese, chromium and alloys thereof.

Diamond growth is provided by dissolving diamond or carbon in molten catalyst and then precipitating diamond from the molten catalyst on to the polycrystalline CVD diamond. For the present invention, the carbon source necessary is an amorphous carbon that has undergone extensive graphitization.

The synthetic diamond that is produced can be made in various colors. Unlike natural diamonds that are most often clear or white, synthetic diamonds can be produced in white as well as colors such as yellow, pink, blue and red. Variations in these colors can also be achieved, if desired. The skilled artisan who is familiar with the technology for creating synthetic diamonds is well aware of the process modifications that can be implemented to achieve the desired color (including white). For example, it is conventional to add dopants to graphite powder, or to anneal white synthetic diamonds to impart colors other than white. As noted above, this invention allows the gift-giver to select the color of the diamond based on the color of the flower or roses that was contemplated as the gift. This creates a more complete remembrance of the gift that can be enjoyed for a much longer time than the flower.

The invention also contemplates a person purchasing one of the synthetic diamonds described herein for their own use. In this embodiment, the gift-giver and the recipient would be the same person.

Also, contemplated by the invention is the situation where the synthetic diamond is conditionally given to another or the diamond is set in jewelry that is loaned or borrowed from the owner. This is typically done in the entertainment industry where jewelry designers loan their creations to recognized actors for the promotion of their designs. These situations are also contemplated by the terms “gift-giver” and “recipient” in this invention.

The synthetic diamond can be mounted or incorporated in any type of jewelry in the same manner as natural diamonds. Thus, a wide variety of rings, earrings, necklaces, pendants, bracelets and the like can be made using the synthetic diamonds of the invention. Of course, the skilled artisan can envision many modifications and alternative embodiments of the invention, and it is intended that all such embodiments be encompassed by the appended claims.

Finally, it is noted that the inventor has an earlier International patent application, PCT/US03/31755 filed Oct. 7, 2003. To the extent that the claims of this application overlap the disclosure and claims of the earlier International application in any particular country where this is not allowed, the overlapping subject matter is disclaimed herein.

1. A method of making a more permanent remembrance from a carbon-containing material that is part of or embodied in an ephemeral object that signifies a power, attribute, memory, custom, tradition, emotion or symbolism associated with a life experience or event, which method comprises providing the ephemeral object; associating the ephemeral object with the life experience or event; and transforming the ephemeral object to the more permanent remembrance by converting the carbon-containing material to a synthetic diamond, thus transferring the power, property, attribute, memory, custom, tradition, emotion or symbolism of the object or the associated life experience or event into the diamond.

2. The method of claim 1, wherein the synthetic diamond is prepared by transforming the carbon-containing material to a carbon or carbon-containing compound; and converting the carbon or carbon-containing compound into the synthetic diamond.

3. The method of claim 2, wherein the carbon compound is graphite and the carbon-containing compound is methane.

4. The method of claim 2, wherein the carbon-containing material comprises or is derived from organic plant material.

5. The method of claim 4, wherein the organic plant material is an edible or non-edible plant, bush, or tree or a fruit or vegetable produced thereby.

6. The method of claim 5, wherein the organic plant material is a flower or tree.

7. The method of claim 2, wherein the carbon-containing material comprises a chemical or component of a beverage, food, perfume, or other liquid-containing product.

8. The method of claim 2, wherein the carbon-containing material is paper, plastic, a polymer, cloth made from a natural or synthetic fiber or yarn, wood, or combinations of these.

9. The method of claim 2, wherein the carbon-containing material represents or is part of a proposed gift that is associated with the life experience or event and only the diamond is bestowed upon a recipient by a gift-giver.

10. The method of claim 9, wherein the gift is first given to the recipient by the gift-giver and the carbon-containing material of the gift is later converted into the synthetic diamond.

11. The method of claim 9, wherein the gift-giver and the recipient are the same person.

12. The method of claim 1, wherein the synthetic diamond has a white, red, pink, yellow or blue color.

13. The method of claim 1, which further comprises bestowing the synthetic diamond on a recipient as a representation of the power, attribute, memory, custom, tradition, emotion or symbolism associated with the life experience or event, wherein the synthetic diamond acts as a container that holds the power, attribute, memory, custom, tradition, emotion or symbolism associated with the life experience or event.

14. The method of claim 13, wherein the life experience or event is an achievement, celebration, vacation, honeymoon, holiday, or season.

15. The method of claim 13, wherein the ephemeral object is represented by or has associated with it a tangible item that includes the carbon-containing material that is transformed to the synthetic diamond.

16. A method of making a more permanent remembrance from a carbon-containing material that is part of or embodied in an ephemeral object that signifies a power, attribute, memory, custom, tradition, emotion or symbolism associated with a life experience or event, which method comprises; associating the ephemeral object with the life experience or event; and transforming the ephemeral object to the more permanent remembrance by converting the carbon-containing material to a synthetic diamond, thus transferring the power, property, attribute, memory, custom, tradition, emotion or symbolism of the object or the associated life experience or event into the diamond; wherein the carbon-containing material comprises a liquid-containing product comprising a beverage, perfume, or a component thereof, or is a material selected from the group consisting of paper, plastic, a polymer, cloth made from a natural or synthetic fiber or yarn, or combinations of these.
